(19) United States
(12) Patent Application Publication
(10) Pub. No.: US 2003/0216937 A1
(43) Pub. Date: Nov. 20, 2003

(54) System and method for providing on-line healthcare

(76) Inventors: Jorg Schreiber, Indianapolis, IN (US); Dan Briggs, Carmel, IN (US); Jane Pickett, Indianapolis, IN (US); Sean Field, Wiesbaden (DE); Gail Rodgers, Oakland, CA (US); Susanne Garbe, Ladenburg (DE)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/145,842

(22) Filed: May 14, 2002

(51) Int. Cl. G06F 17/60

(52) U.S. Cl. 705/2

(57) ABSTRACT

The present invention provides a system and method for providing on-line healthcare, including receiving, over a network, symptom information for a patient from a person requesting healthcare, generating a health assessment based on the symptom information, and providing an on-line facility whereby a healthcare provider communicates over the network with the person requesting healthcare. The present invention further includes a system and method for ordering prescriptions over a network, transmitting the health assessment to a patient's personal physician over a network, and providing a physician referral for the patient. The present invention also provides for on-line follow-up with the patient after a health assessment is generated.

### BACKGROUND

The present invention relates to the field of computer software, in particular, computer software applications for providing on-line healthcare.

Computer systems exist today that receive patient-described symptom information, evaluate the information according to medical algorithms, and provide automated diagnostic information, for example, U.S. Pat. Nos. 6,014,631, 6,047,259, 6,168,563, and 6,206,829.

However, prior art systems do not directly involve the healthcare provider in evaluating, on-line, a preliminary computer-generated diagnosis created based on symptoms input by a patient, or a person requesting healthcare on behalf of a patient, such as a parent or a caregiver (hereinafter, “a user”). In particular, a system that analyzes symptoms articulated by the user and directly involves a healthcare provider to determine a diagnosis and treatment plan based on those symptoms is desired, in lieu of a system that is primarily disease- or condition-related. Prior art systems often require the user to self-assess his or her symptoms and then search for relevant information in the system, without any guidance from a healthcare professional. A further shortcoming of prior art systems is that users are generally unable to automatically notify their personal physician of the treatment received via the on-line system or integrate the medical records generated by the on-line system with the medical records maintained by their primary care physician.

An improved system for providing on-line healthcare with the direct involvement of healthcare providers is desired to address these and other shortcomings of the prior art.

### SUMMARY OF THE INVENTION

The present invention is directed to an on-line healthcare system and method for providing consumer diagnosis and treatment, which addresses the above-described shortcomings and other disadvantages of the prior art.

In accordance with the present invention, a method for providing on-line healthcare is provided. The method comprises the steps of receiving, over a network, patient symptom information from a user, generating a health assessment of the patient based on the patient symptom information; and providing an on-line facility whereby a healthcare provider communicates over the network with the user about the on-line health assessment. The health assessment may include a prescription, and the prescription may be filled over the network by the user.

The method may also provide for communicating the health assessment over the network to the user's personal physician. Further, the method may provide the user with a referral for medical treatment. Also, the method may provide for follow-up with the user after the health assessment is generated.

Also in accordance with the present invention, a further method for providing on-line healthcare is provided. The method comprises the steps of receiving at a main computer a symptom transmitted by a user via a first remote computing device, the main computer and the first remote computing device being connected by a network, generating at the main computer a health assessment based on the symptom, receiving at the main computer input regarding the health assessment transmitted by a healthcare provider via a second remote computing device connected to the network, providing a facility whereby the healthcare provider and the user communicate regarding the health assessment over the network using the first and second remote computing devices, and communicating a treatment plan to the user over the network.

Further in accordance with the present invention, a computer program is provided. The program includes a first routine for receiving patient symptom information from a user requesting healthcare, a second routine for generating a health assessment based on the symptom information, a third routine for receiving input over a network from a healthcare provider regarding the health assessment, and a fourth routine for facilitating on-line communication relating to the health assessment between a healthcare provider and the user. The program may also include a fifth routine, directed to the physician, for writing prescriptions on-line.

Also in accordance with the present invention, an on-line healthcare system is provided, including network means for providing a communication network, means for receiving patient symptom information from a user over the network means, processor means coupled to the network means, means for generating an on-line health assessment based on the symptom information, and means for enabling a physician to provide input relating to the on-line health assessment to the user over the network means.

Further in accordance with the present invention, means for providing on-line real time communication between the physician or other healthcare provider and the user may be provided.

Additional features of the present invention will become apparent to those skilled in the art upon consideration of the drawings of the illustrated embodiments and accompanying description.

### BRIEF DESCRIPTION OF THE DRAWINGS

FIG. 1 is a block diagram of an embodiment of the present invention;

FIG. 2 is an overview flow diagram of the operation of the embodiment of FIG. 1;

FIG. 3 is a flow diagram of a procedure for receiving patient information;

FIG. 4 is a flow diagram of a procedure for receiving symptom information;

FIG. 5 is a flow diagram of a procedure for generating a health assessment and treatment plan;

FIG. 6 is a flow diagram of a procedure for verifying the health assessment and treatment plan;

FIG. 7 is a flow diagram of a procedure for presenting the health assessment, treatment plan, and other options;

FIGS. 8, 9 and 10 are screen displays for receiving patient information;

FIGS. 11 and 12 are screen displays for receiving symptom information;

FIG. 13 is a screen display for generating a health assessment;

FIGS. 14, 15, and 16 are screen displays for verifying a health assessment;

FIG. 17 is a screen display for generating a prescription;

FIG. 18 is a screen display for presenting a health assessment, including a treatment plan, and options, to the user;

FIGS. 19 and 20 are screen displays for ordering a prescription;

FIG. 21 is a screen display for sending information to a physician;

FIG. 22 is a screen display for requesting a referral;

FIG. 23 is a flow diagram of a procedure for on-line follow-up treatment; and

FIG. 24 is a flow diagram of a procedure for communicating with a patient's personal physician.

### DETAILED DESCRIPTION OF EMBODIMENTS OF THE INVENTION

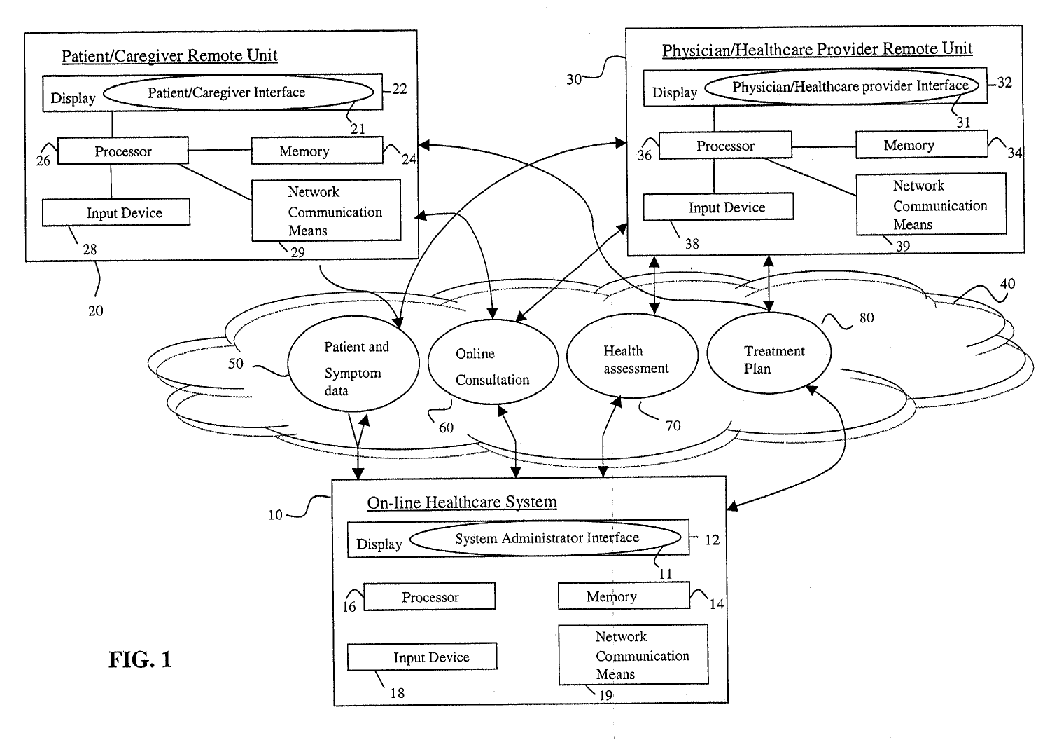

An exemplary embodiment of the present invention is shown in FIG. 1. As shown in FIG. 1, on-line healthcare system 10, patient/caregiver remote unit 20, and physician/healthcare provider remote unit 30 are in network communication via communications network 40.

On-line healthcare system 10 includes a display 12 on which is shown a graphical system administrator interface 11, at least one processor 16 that executes computer program instructions to operate the on-line healthcare system 10, a computer-readable medium or memory 14 in which is stored information, including programming instructions, required for the operation of on-line healthcare system 10, at least one input device 18 that may be used to input information required for the operation of the on-line healthcare system 10, and network communication means 19, which facilitates network communication between on-line healthcare system 10 and each of patient/caregiver remote unit 20 and physician/healthcare provider remote unit 30.

Patient/caregiver remote unit 20 includes a display 22 on which is shown a graphical patient/caregiver interface 21, at least one processor 26, a computer readable medium or memory 24, at least one input device 28, and network communication means 29 to enable communication between remote unit 20 and on-line healthcare system 10 and physician/healthcare provider remote unit 30.

Physician/healthcare provider remote unit 30 includes a display 32 on which is shown a graphical physician/healthcare provider interface 31, at least one processor 36, computer readable medium or memory 34, at least one input device 38, and network communication means 39, to enable communication between remote unit 30 and on-line healthcare system 10 and patient/caregiver remote unit 20.

Displays 12, 22, and 32 may be computer monitors, television screens, or other cathode ray tube devices, liquid crystal displays (LCDs), or similar devices for electronically displaying information, including, but not limited to, those found in personal computers, handheld digital devices such as personal digital assistants, wireless phone/digital assistant combinations, or similar devices.

Processors 16, 26, and 36 may each be microprocessors or a plurality of microprocessors having a processing capability and clock speed sufficient to perform the operations required by on-line healthcare system 10, patient/caregiver remote unit 20, and physician/healthcare provider remote unit 30, respectively. In one embodiment, processors 16, 26, and 36 operate operating system software, such as Unix, Microsoft Windows or Apple Macintosh, or a combination thereof, as well as Internet browser software, such as Microsoft Internet Explorer or Netscape Navigator, in addition to the computer programs of on-line healthcare system 10.

Computer-readable media or memory 14, 24, and 34 may be random-access memory, flash memory, or similar storage media sufficient for storage and/or caching of operating system software, Internet browser software, and the computer programs of the on-line healthcare system, including the graphical interfaces 11, 21, and 31. In one embodiment, memory 14 includes a computer-readable storage structure for storing patient, symptom, health assessment, treatment, physician/healthcare provider, prescription, and other information used by the on-line healthcare system. Such structure may include a database, or a plurality of databases distributed on one storage medium or on a plurality of storage media connected over a network.

Input devices 18, 28, and 38 may be computer keyboards, keypads, buttons, digital styluses or “pens,” microphones coupled to voice recognition systems, touch pads, computer mouses, trackballs or joysticks, or other similar devices used to input information in a computer-readable form. Also, video cameras and/or voice recorders may be used to enable the user and the healthcare provider to see and/or hear each other during an on-line visit. Recorded audio or video may be implemented in real time, or stored and re-played by the user or healthcare provider at a later time. Further, input devices 18, 28, 38 may include home diagnostic or medical testing, sensing or monitoring devices such as body temperature sensors, blood pressure monitors, blood glucose monitors, or the like, thus enabling the healthcare provider to obtain current vital medical information from the user and consider such information in creating the diagnosis and treatment plan.

Network communication means 19, 29, and 39 are communication facilities including software and hardware for enabling network communication between computing devices, for example, via fax, telephone or cable modem, ISDN, DSL, or wireless connection. Also, a means for rendering the network communications secure is provided, for example, encryption and Secure Socket Layer (“SSL”) technology.

One of ordinary skill in the art would be able to readily determine a suitable configuration of displays, processors, memory, input devices, and network communication means for operation of the present invention, in view of, for example, the anticipated volume of data to be received, number of users, frequency of use, and network capacity.

As shown in FIG. 1, communication network 40 is used to communicate patient and symptom data 50 from patient/caregiver remote unit 20 to on-line healthcare system 10 and to physician/healthcare provider remote unit 30, to communicate a heath assessment 70 and treatment plan 80 from on-line healthcare system 10 to patient/caregiver remote unit 20 and to/from physician/healthcare provider remote unit 30, and to facilitate on-line consultation 60 between patient/caregiver remote unit 20 and physician/healthcare provider remote unit 30. Communication network 40 is an electronic and/or wireless network which links computers and/or other computing devices (such as handheld devices) in various geographic locations, such as a local area network, intranet, extranet, or global network. In one embodiment, communication network 40 is the Internet and interfaces 11, 21, and 31 are displayed as web pages using the World Wide Web.

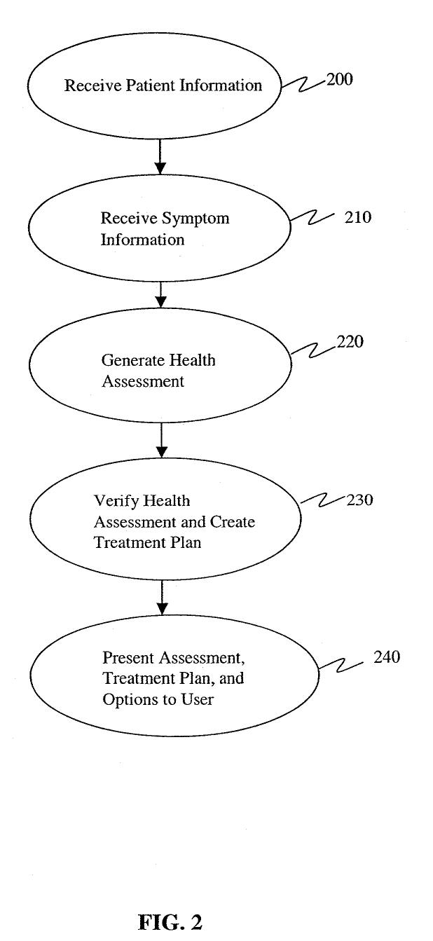

In FIG. 2, an overview flow diagram of the operation of the system and method of an embodiment of the present invention is shown. At step 200, patient information is received by on-line healthcare system 10, over network 40, from a user. If the user is approved, symptom information for the patient is received by on-line healthcare system 10, via network 40, at step 210. At step 220, a health assessment 70 is generated by system 10 based on the patient and symptom information 50. In the illustrated embodiment, the health assessment 70 includes a preliminary diagnosis of the patient's medical condition. The health assessment 70 is reviewed and verified on-line by a qualified healthcare provider, such as a physician, at step 230. Also, at step 230, the healthcare provider creates a treatment plan 80 for the patient based on his or her review of the health assessment 70 and/or the patient and symptom information 50. At step 240, the health assessment 70 and treatment plan 80, as well as additional healthcare options, are presented to the patient or the user.

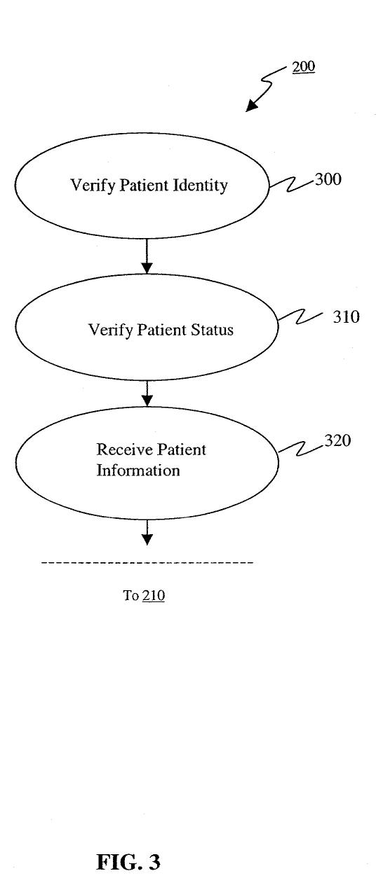

In FIG. 3, a flow diagram of a procedure for receiving patient information at step 200 of FIG. 2 is shown. At step 300, a user logs in to on-line healthcare system 10, for example, by inputting a user name and password via input device 28 and patient/caregiver interface 21. If the user is not a patient, the user identifies the patient for whom on-line healthcare is being requested. The patient's identity is verified, for example, by validating the patient's password, first name, last name, unique identifier (such as a Social Security Number), date of birth, and/or mother's maiden name. At step 310, the patient's status, i.e., whether the patient is an adult or a minor, is verified, for example, by checking the patient's date of birth and/or Social Security Number. At step 320, patient information, including contact information (such as address, telephone number, and email address), payment information, personal medical history (including allergies, medications, and past medical conditions), family medical history, personal information (such as age, race, height and weight), personal physician, and preferred pharmacy, is input by the user. Due to differing laws and/or regulations in different jurisdictions, the services offered by system 10 may not be available in all locales. When the user inputs a geographic location or address, system 10 determines whether such location is one in which its on-line healthcare services are available. If the services are not available in the specified jurisdiction, the system 10 so notifies the user via network 40. Each time a user requests on-line healthcare for a patient, the user is prompted to update the patient information if necessary.

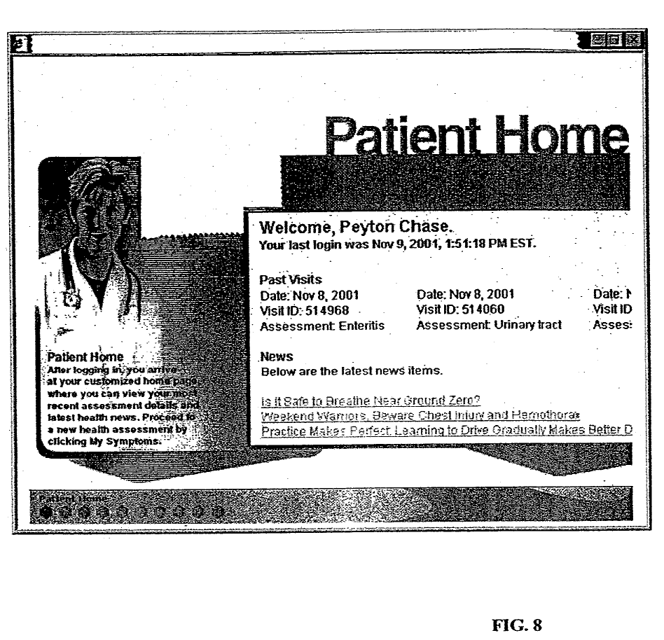

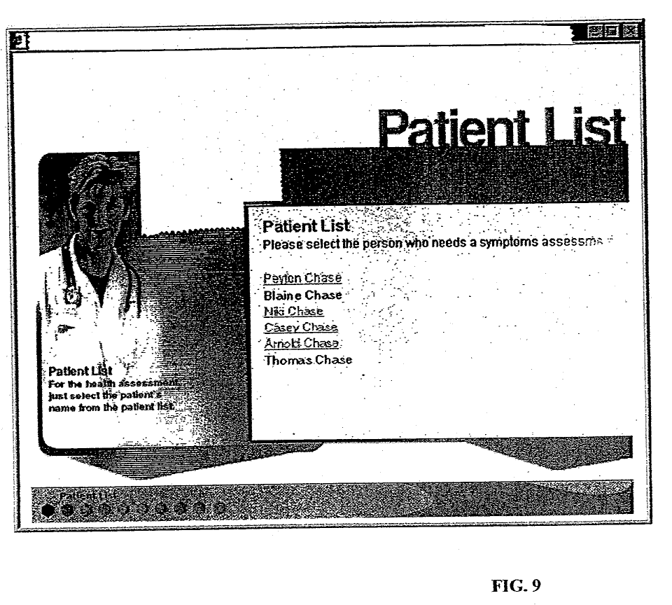

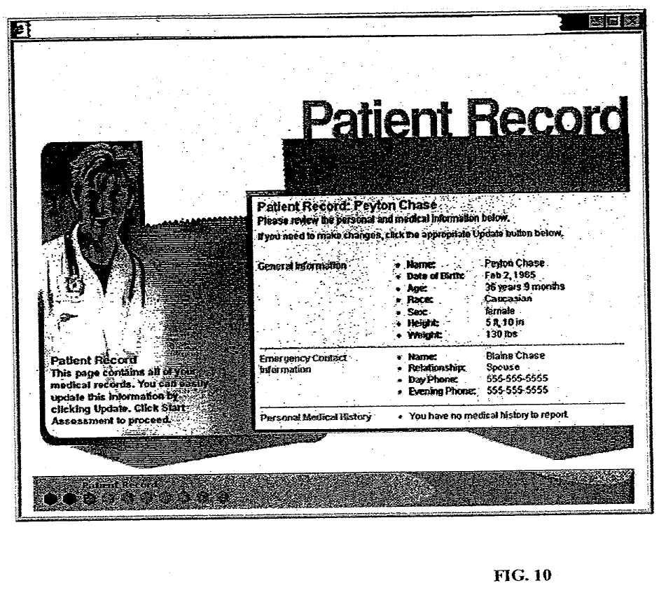

FIGS. 8, 9, and 10 show exemplary screen displays of patient/caregiver interface 21 for use in verifying patient identity and receiving patient information. FIG. 8 shows a graphical display that is shown after the user has successfully logged in by inputting a valid user name and password. FIG. 9 shows a list of patients for whom the user may request on-line healthcare. To select a patient, the user clicks on or otherwise selects the name of the patient. FIG. 10 shows a display of the patient information associated with the patient selected at FIG. 9. The user is requested to verify the patient information by activating an “update” button (not shown) before proceeding.

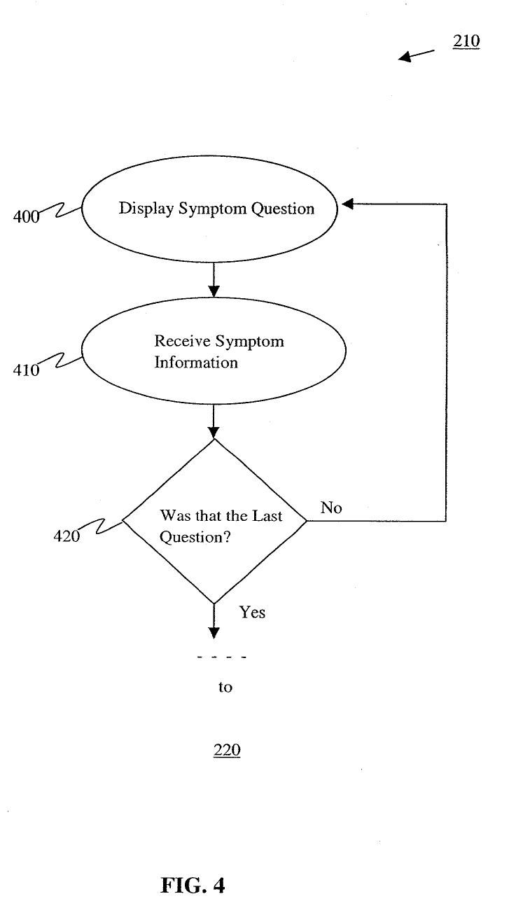

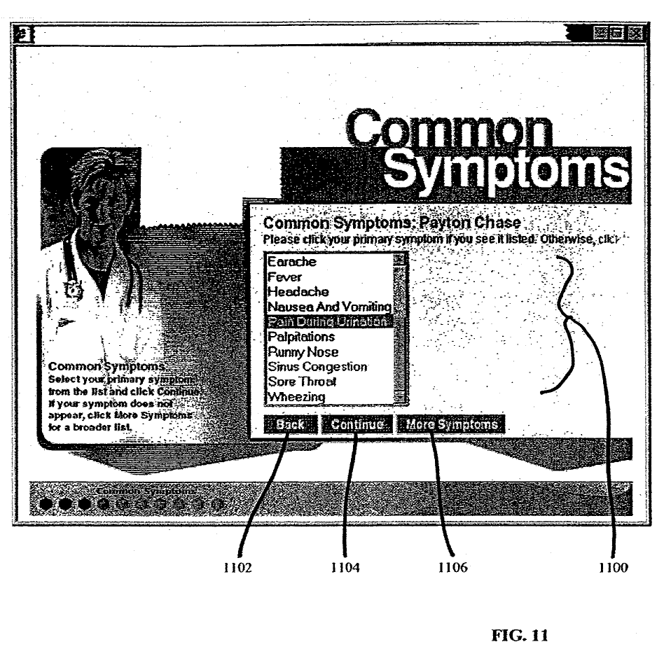

FIG. 4 shows a flow diagram of a procedure for receiving a patient's symptom information at step 210 of FIG. 2. At step 400, a question relating to symptoms is displayed to the user via patient/caregiver interface 21. FIG. 11 shows an exemplary graphical display for obtaining primary symptom information. In FIG. 11, the user selects a symptom from a list 1100. If the desired symptom does not appear in list 1100, the user activates a “More Symptoms” button 1106, and a larger list of symptoms is displayed. If the user desires to return to a previous screen display, such as one of the patient information displays shown in FIGS. 9 and 10, the user activates a “Back” button 1102. After the user has selected a primary symptom, the user activates a “Continue” button 1104. Symptom information is received by on-line healthcare system 10 over network 40 at step 410 of FIG. 4.

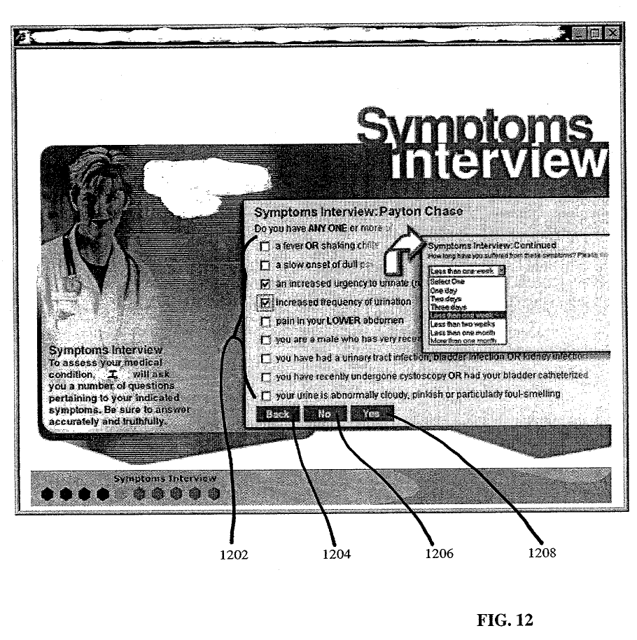

At step 420, programming logic contained in on-line healthcare system 10 determines whether additional symptom questions need to be asked of the user, based on answers to previous questions input by the user and established medical algorithms known in the art. If another symptom question needs to be asked, the next symptom question is dynamically displayed to the user at step 400. FIG. 12 shows an exemplary screen display for obtaining additional symptom information. As shown in FIG. 12, the user may choose one or more of the check boxes 1202 to provide additional symptom information. The user activates a “Back” button 1204 to go back to a previous screen display, or a “No” button 1206, or a “Yes” button 1208, as appropriate, to complete the response to the symptom question and proceed to the next screen display. Once complete, the symptom information is electronically submitted to a healthcare provider who has access to on-line healthcare system 10 via physician/healthcare provider interface 31. The healthcare provider may be a doctor, nurse, or other healthcare provider.

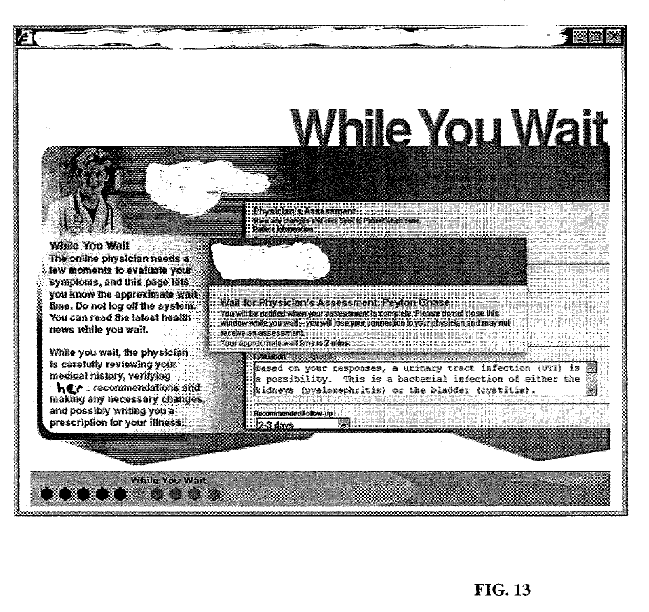

FIG. 13 shows an exemplary graphic displayed to the user via patient/caregiver interface 21 while health assessment 70 is being generated from the patient symptom information and verified by a healthcare provider, and treatment plan 80 is being created by the healthcare provider. In the illustrated embodiment, the user remains connected on-line to healthcare system 10 over network 40 while the health assessment 70 and treatment plan 80 are being generated. An indication of the wait time for completion of the health assessment 70 and treatment plan 80 may be displayed to the user for example, as shown in FIG. 13. Further, the user may activate a hyperlink, which enables the user to read the latest health news and information while awaiting completion of the health assessment 70 and treatment plan 80. Each health assessment 70 and treatment plan 80 is personal to the user/patient and specific to the set of symptom information input by the user for the patient during the current session.

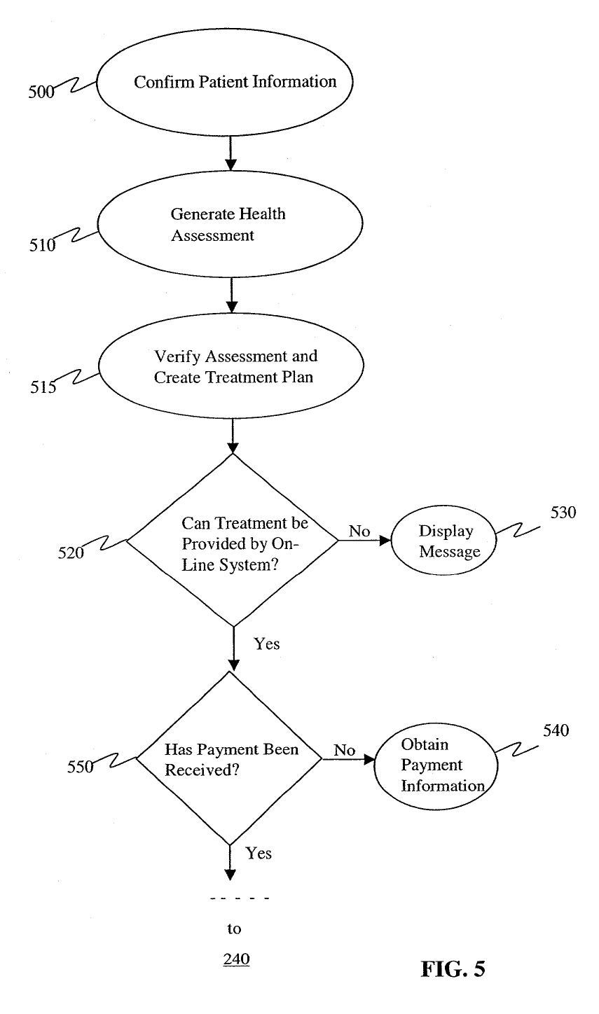

FIG. 5 depicts a procedure for generating a health assessment 70 and creating treatment plan 80. At step 500, the pertinent patient information is confirmed. For example, the user is asked to input any pertinent updates to the patient's medical history. The health assessment 70 is automatically generated using computer programming logic implementing previously established medical algorithms for analyzing symptoms. In one embodiment, these medical algorithms include well-known methods for diagnosing and caring for acute illnesses. At step 515, system 10 presents health assessment 70 to the healthcare provider via interface 31 over network 40, and the healthcare provider reviews and verifies assessment 70 and creates treatment plan 80. Step 515 is described in greater detail below. At step 520, programming logic is used to verify whether the patient's condition is one for which an assessment and/or treatment plan can be provided by on-line system 10. Exhibit A shows a list of examples of medical conditions that can be treated by physicians on-line using the system of the present invention. If the patient's medical condition, or the treatment thereof, cannot be handled by the on-line system 10, for example, if it is an emergency medical condition, a message is displayed to the user at step 530 instructing the user to, for example, consult his or her personal physician or proceed to an emergency room. In one embodiment, the user is not charged for a use of the on-line system if the condition is not one that can be handled on-line.

If the patient's condition can be treated on-line, programming logic is used to check whether payment has been received for the on-line treatment at step 550. If payment information has not been received, payment information is obtained at step 540. In one embodiment, payment for on-line treatment can be charged to personal credit cards. Additionally, a user's employer may provide use of the on-line system 10 as part of a healthcare benefits package. In such event, the treatment may be prepaid by the employer in the form of “credits” allocated to the user, such that a credit is used each time a treatment is provided for the user.

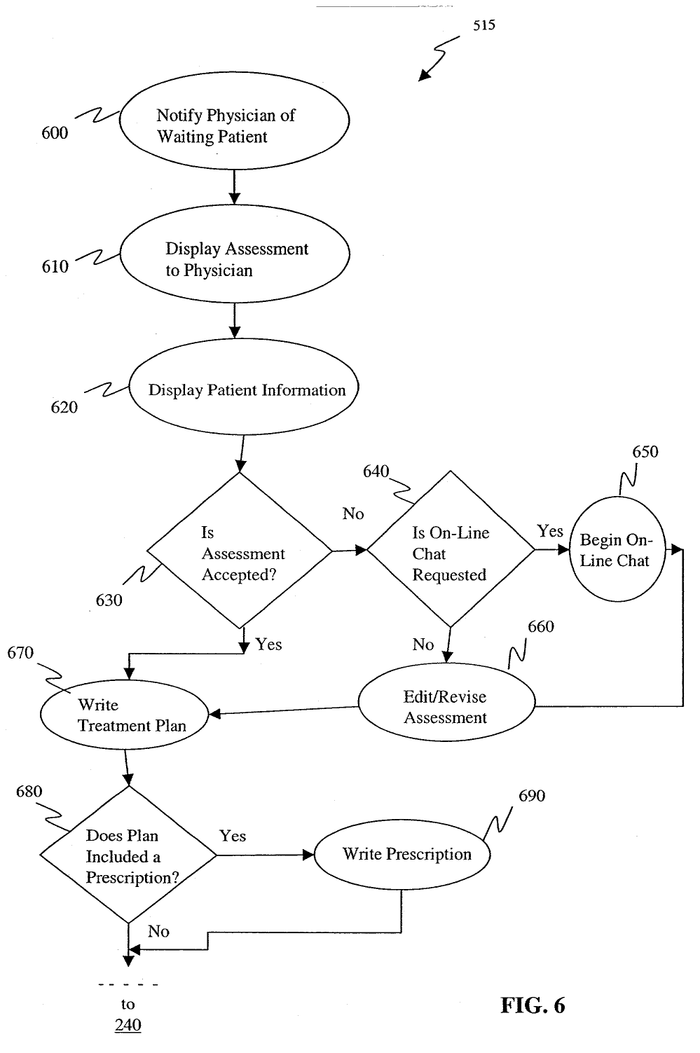

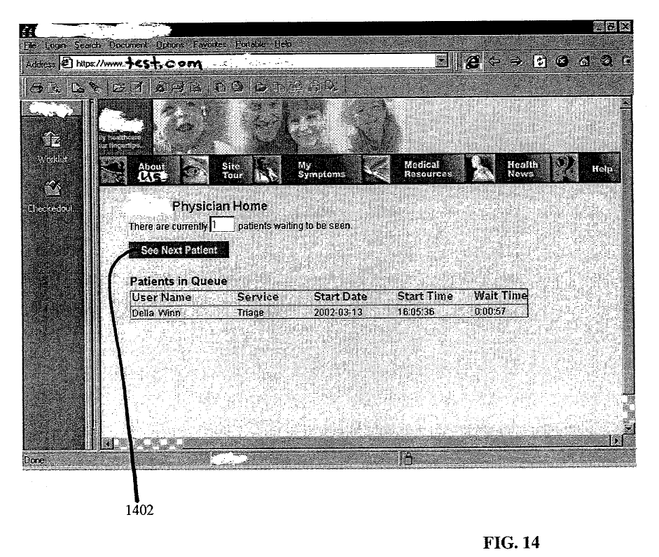

FIG. 6 shows a flow diagram of the process by which a healthcare provider reviews and verifies the automatically-generated health assessment and creates a treatment plan at step 515 of FIG. 5. At step 600, the healthcare provider is notified on-line via network 40 that a user is waiting for treatment. An audible alarm or simulated “doorbell” sound may be generated by system 10 at physician/healthcare provider remote unit 30 when a patient is waiting. FIG. 14 shows an exemplary screen display shown to the healthcare provider via interface 31 when a user is waiting for on-line treatment. In one embodiment, the name, service type, date, time, and elapsed wait time are displayed for each patient in the queue. The healthcare provider may activate a “See Next Patient” button 1402 to review the previously generated health assessment for the next patient in the queue. The “next patient” may be the patient with the longest elapsed wait time, the most serious condition, or the patient satisfying some other criteria.

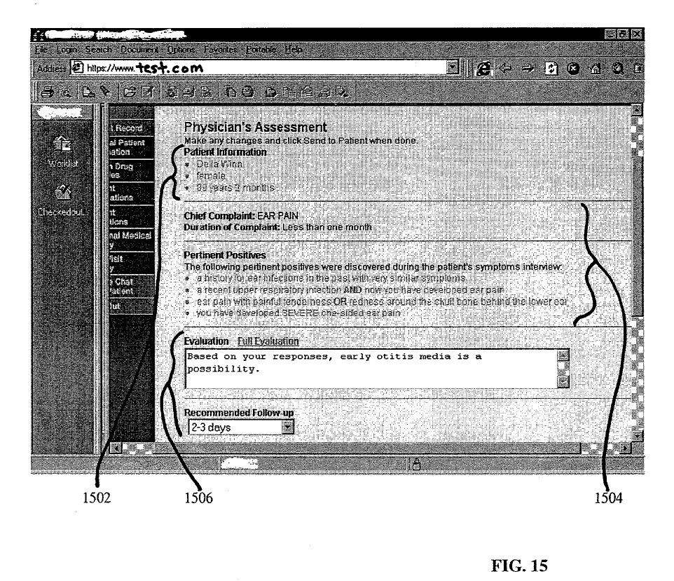

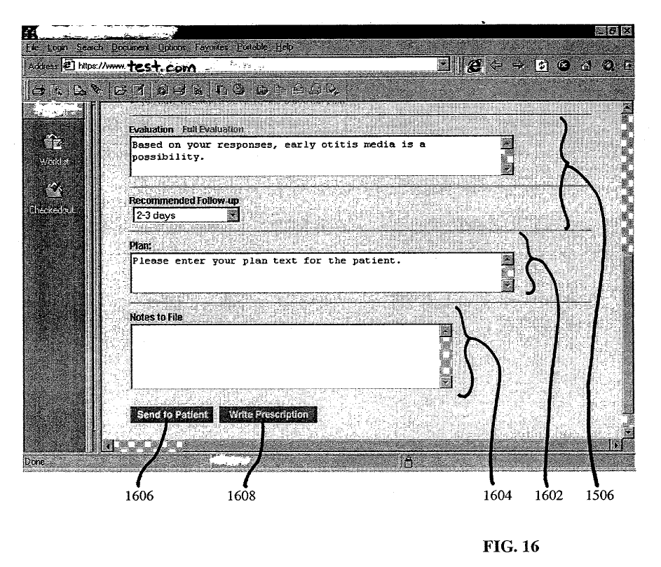

The automatically-generated health assessment 70 for the patient is displayed to the healthcare provider via interface 31 at step 610. Pertinent information about the patient is displayed at step 620. FIGS. 15 and 16 show exemplary screen displays showing the health assessment 70 and patient information 50. FIG. 15 shows the pertinent patient information 1502, patient symptom information 1504 obtained via step 210, and text boxes containing the automatically generated assessment 1506. FIG. 16 continues the display of FIG. 15, further showing a treatment plan text box 1602, and a healthcare provider notes text box 1604. In the embodiment of FIGS. 15 and 16, text boxes 1506, 1602, and 1604 can be edited by the physician or other healthcare provider, as the provider deems appropriate based on patient information 1502 and/or symptom information 1504, to create the treatment plan 80. After the healthcare provider completes the treatment plan 80, the healthcare provider activates either button 1606 or 1608 to send the assessment 70 and treatment plan 80 to the user or to generate a prescription for the patient.

As shown in FIG. 6, the healthcare provider is prompted at step 630 to decide whether to accept the automatically-generated assessment. If the healthcare provider wants more information before accepting the assessment, the provider can request at step 640 an on-line real time “chat” with the user. The on-line chat is initiated via programming logic, for example, using instant-messaging technology, and network communication means 19,29, and 39 over network 40, at step 650. If the automatically-generated health assessment 70 is not acceptable to the provider, but the provider has sufficient information to render an assessment and provide a treatment plan, the provider may, at step 660, revise the assessment or create a new assessment via interface 31. At step 670, the provider creates a treatment plan for the patient on-line via interface 81. Illustratively, the provider creates the treatment plan by typing text instructions into text boxes on interface 31, but other methods of input may also be used. In other embodiments, predefined instructions may be selected by the provider, for example, by clicking a mouse button. Instructions may be predefined based on the medical condition or diagnosis, or other criteria. For example, a phrase such as “follow-up recommended in 24 hours” may be predefined and linked to one or more conditions, so that the same instruction appears consistently and eliminates the need for the provider to retype or re-enter the same phrase repeatedly. This feature also may reduce the risk of error in creation of the treatment plan.

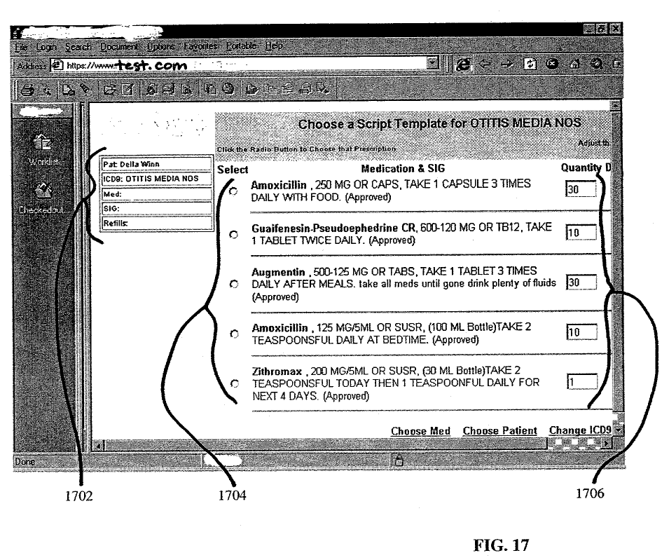

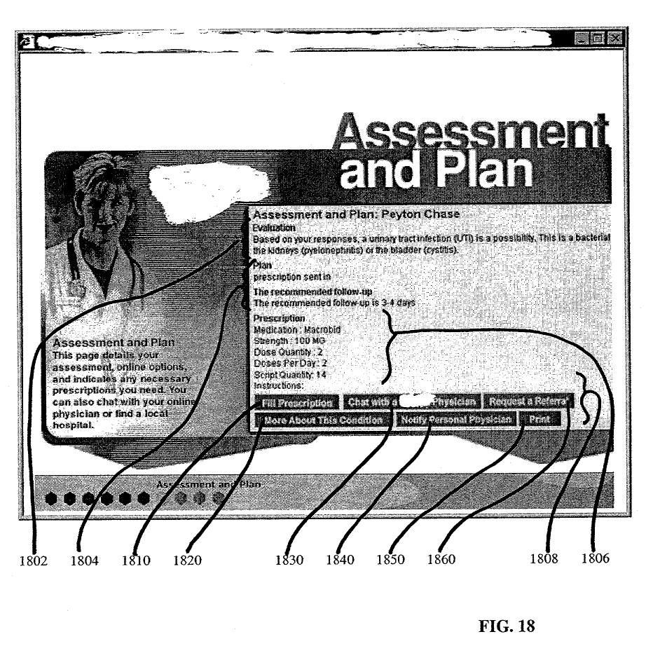

FIG. 17 shows an exemplary screen display for a physician to generate a prescription, which is displayed, for example, if the “Write Prescription” button 1608 (FIG. 16) is activated. As shown in FIG. 17, the patient name, diagnosis, and other pertinent information are displayed at text area 1702. To select a medication for prescription, the healthcare provider activates one of the radio buttons 1704 corresponding to the selected medication. For the selected medication, the provider edits the corresponding text box 1706 to specify the appropriate quantity for the prescription. In one embodiment, the prescription information is displayed to the user as part of the treatment plan, as shown in FIG. 18. Pre-defined prescription instructions may be used in the same manner as the predefined treatment instructions described above. For example, a physician may pre-define instructions, such as “take twice daily with meals,” which can then be selected automatically with a keystroke or mouse click, or linked to particular prescriptions.

In one embodiment, a physician or other healthcare provider is connected to system 10 on-line at all times, to enable patients to receive a response to their inquiries at any hour of the day. Accordingly, an additional feature provided by system 10 is the ability to establish schedules for staffing the on-line healthcare service with physicians and/or other healthcare providers. In this embodiment (not specifically illustrated), the staffing schedules are maintained on-line through programming logic as part of system 10. This feature enables the healthcare providers to establish their work schedules with respect to the on-line system 10 via interface 31, and to adjust their schedules, for example, by exchanging scheduled dates or times with other providers if they have a conflict with a scheduled date or time, over network 40.

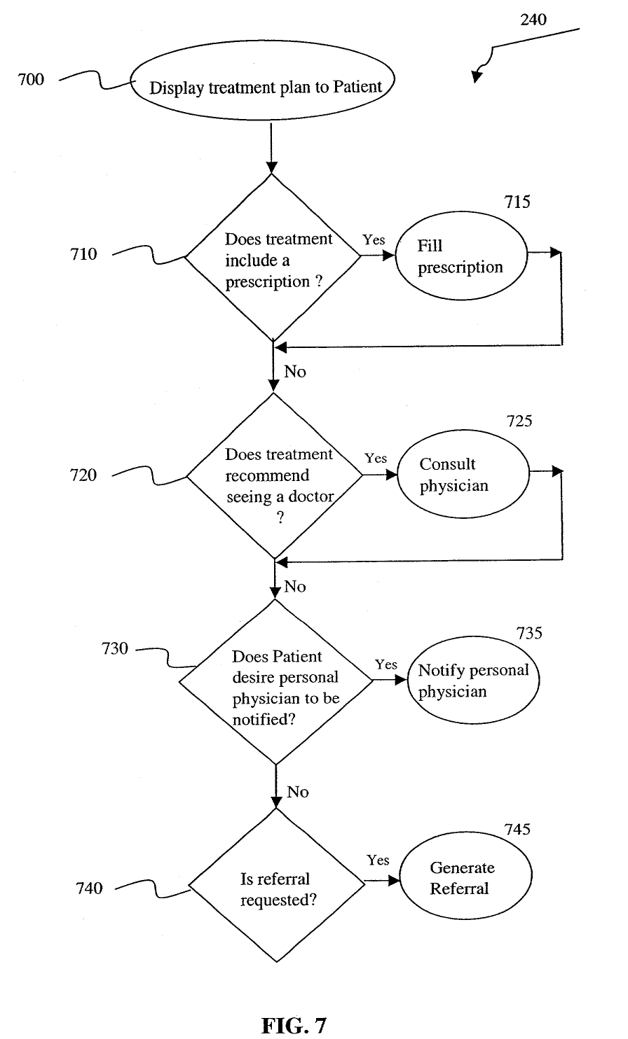

FIG. 7 depicts a procedure for presenting the provider-created treatment plan 80 and other options to the user. At step 700, the treatment plan 80 is displayed via patient/caregiver interface 21. As shown in FIG. 18, all or portions of assessment 70 may also be shown to the user. FIG. 18 shows an exemplary patient/caregiver screen display for the treatment plan 80 and options. As shown in FIG. 18, the provider-approved health assessment 70 is displayed in text area 1802, the recommended treatment is displayed in text area 1804, and the prescription information (if any) is displayed in text area 1806. A series of options 1808 may be presented to the user via buttons 1810, 1820, 1830, 1840, 1850, and 1860.

At step 710 of FIG. 7, on-line healthcare system 10 determines whether the treatment plan for the patient includes a prescription. If the treatment plan includes a prescription, option 1810 is displayed and a procedure for ordering the prescription is executed at step 715, as is further described below. At step 720, on-line healthcare system 10 determines whether the treatment plan recommends consulting an on-line physician. If the treatment plan recommends consulting an on-line physician, or if the user otherwise elects to consult an on-line physician, e.g., by activating button 1830, a procedure for consulting a physician on-line is invoked at step 725. In one embodiment, this procedure includes initiating a real-time on-line “chat,” using known computer programming methods, between the user and the healthcare provider as described above.

At step 730, the user is provided with an option to notify a personal physician of the existence of the on-line health assessment 70 and treatment plan 80 and/or provide the assessment and treatment information to a personal physician, e.g., via button 1840. If the user selects this option, e.g., by activating button 1840, a procedure is executed at step 735 to notify the patient's personal physician or send the assessment and treatment information to the personal physician as further described below.

At step 740, the user is presented with an option to request a referral to a physician at a local hospital, e.g., via button 1860. At step 745, a procedure is invoked to automatically request a referral if the user selects this option, e.g., activating button 1860, as is further described below. As shown in FIG. 18, a user may also print a copy of the health assessment and treatment plan by activating button 1850, for example, to make an appointment with the patient's personal physician. Also shown in FIG. 18 is button 1820, which, if activated by the user, displays more detailed information about the medical condition included in the patient's diagnosis.

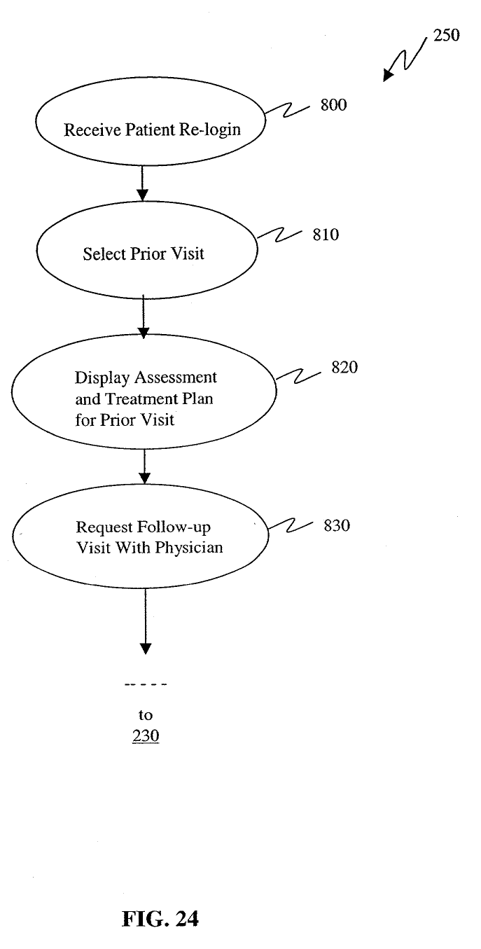

The present system also provides for on-line follow-up by a patient, with respect to a previous visit, within a predetermined time after an initial assessment. FIG. 24 illustrates a process for providing this on-line follow-up feature 250. In one embodiment, a follow-up is scheduled within forty-eight hours. Another time period for follow-up may be determined based on the nature of the assessment and/or treatment plan. At step 800, a user or patient re-connects to system 10 by logging in as described above. On re-login in the system 10, the patient sees a display of prior three visits (alternatively the user may access prior visits through a search of prior history) on interface 21. This display shows, for example, the date of each prior visit and the corresponding diagnosis. At step 810, the user selects the diagnosis or visit date on which they are seeking follow-up. At step 820, the details of the physician assessment and plan written at the selected visit or for the selected diagnosis are displayed to the user. The patient then requests a follow-up visit with the physician by on-line chat or other mechanism at step 830. The prior visit is re-submitted to the physician along with any questions of concern or clarification submitted by the user. At this time, the physician can change the assessment or treatment plan, revise the treatment plan and delete or add prescriptions, on-line, as necessitated by the patient's situation.

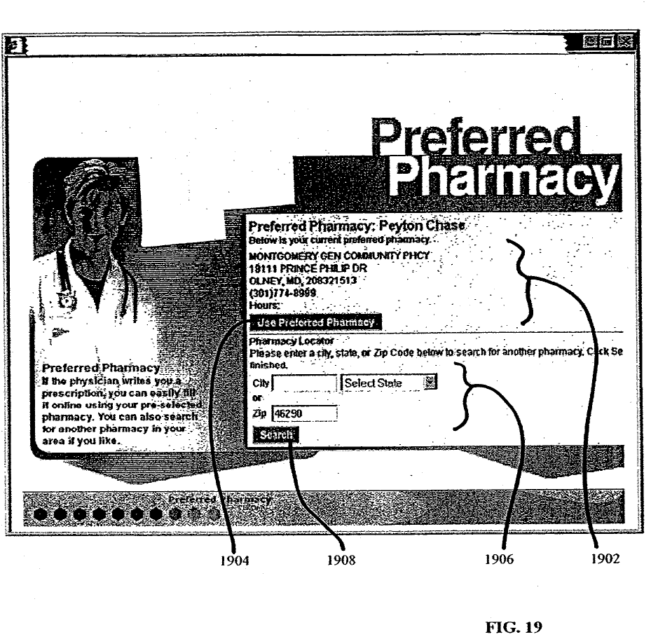

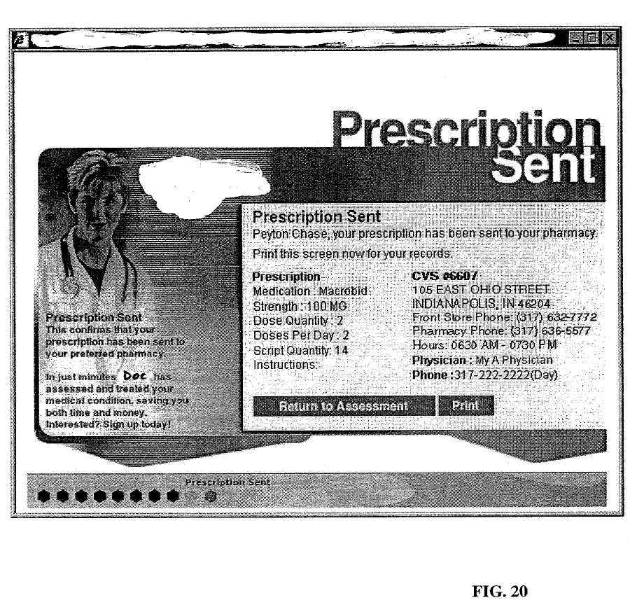

In one embodiment, if a prescription is required, the physician can automatically submit the prescription to a cooperating pharmacy, or a pharmacy of the user's choice, through on-line prescription services. FIGS. 19 and 20 show exemplary screen displays presented to the user via interface 21 for ordering a prescription that has been generated for the patient as part of the on-line health assessment. Text area 1902 of FIG. 19 shows the patient's preferred pharmacy information, which has been previously input by the user at step 200. If the user elects to have the prescription filled at the preferred pharmacy, the user activates button 1904. If the user elects to fill the prescription at a different pharmacy (for example, if the patient is away from home on business or vacation), the user inputs geographic location information in the city, state, or zip code text boxes in input area 1906. Once the location information is filled in, the user activates a search button 1908, and programming logic executes a search routine to identify a pharmacy in the desired geographic location. FIG. 20 shows a printable confirmation display, which confirms that the prescription has been sent to the requested pharmacy.

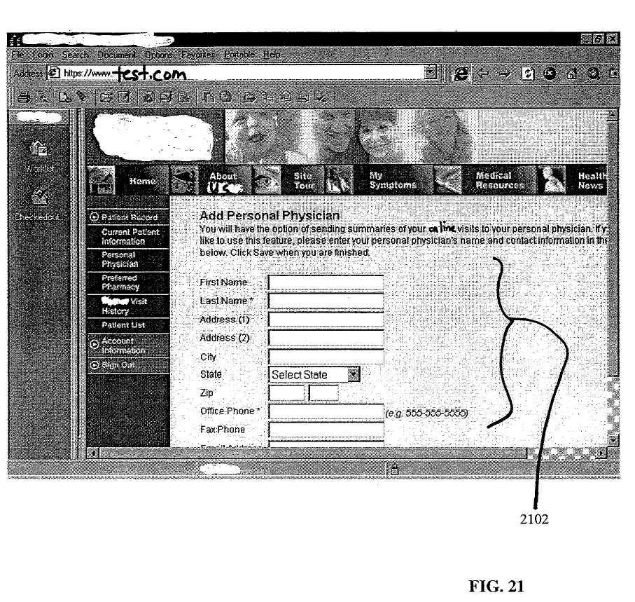

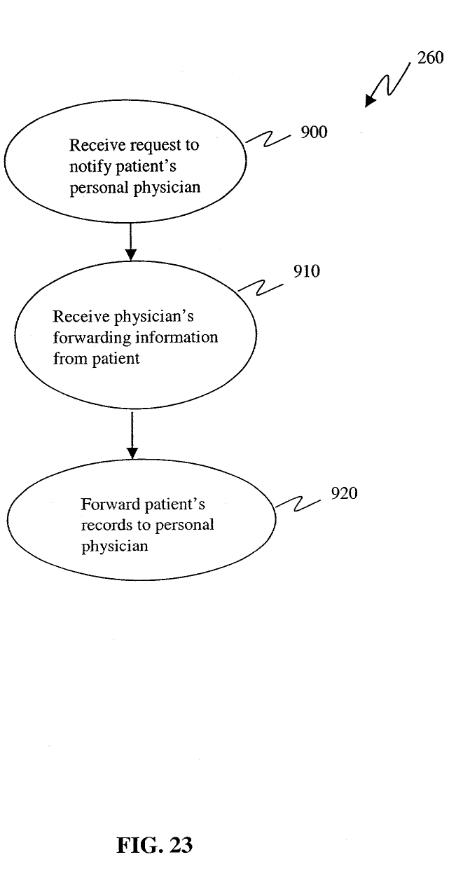

In one embodiment of the present invention, on-line healthcare system 10 enables the user to integrate results of each visit to the web site into the records of the patient's physician. FIG. 21 shows a screen display for providing the on-line assessment and treatment plan information to a personal physician. FIG. 23 shows a process 26 for transmitting a patient's on-line healthcare data to the patient's personal physician. As shown in FIG. 23, if the user elects to electronically send on-line healthcare information to a personal physician, the user requests the same at step 900. The user then inputs the name and contact information for the physician in the text boxes in input area 2102 at step 910. When the user has finished inputting the physician information, the user activates a “Save” button (not shown). At step 920, programming logic executes computer instructions to electronically send information to the personal physician over network 40 using email, fax, or other similar known utilities. This operation is preferably performed electronically, but may be accomplished by e-mail, telephone, fax, or other method of communication.

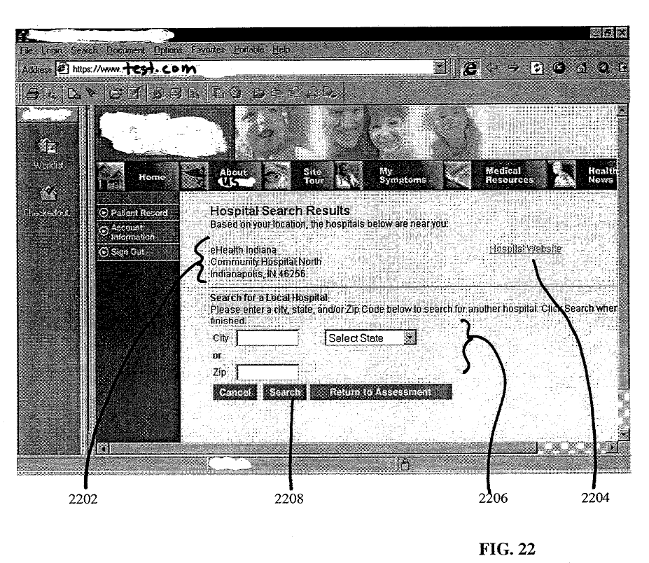

FIG. 22 shows a screen display for requesting a referral to a physician at a local hospital, for example, if the patient does not have a personal physician or is traveling away from home. In one embodiment, hospital information is displayed in text area 2202 based on the user's geographic location, as previously input at step 200. A hyperlink 2204 provides a network connection to the hospital's web site, providing more detailed information about the hospital. If the listed hospital is not selected by the user, the user may search for a different hospital referral based on a geographic location by inputting city, state, or zip code search criteria in input area 2206 and activating the “Search” button 2208. In the illustrated embodiment, a geographic information system, including city and zip code searches, is used to locate physicians and hospital referrals.

Although the present invention has been described in detail with reference to certain exemplary embodiments illustrated in the drawings, variations and modifications exist with the scope and spirit of the present invention as defined and described in the following claims.

What is claimed is:

1. A method for providing on-line healthcare, the method comprising the steps of:
receiving, over a network, patient symptom information from a user,
generating a health assessment of the patient based on the patient symptom information, and
providing an on-line facility whereby a healthcare provider communicates over the network with the user about the health assessment.

2. The method of claim 1, further comprising the step of communicating to the user, over the network, a treatment plan created by the healthcare provider relating to the health assessment.

3. The method of claim 2, wherein the treatment plan includes a prescription.

4. The method of claim 3, further comprising the step of filling the prescription over the network.

5. The method of claim 4, further comprising the step of identifying a pharmacy from which to fill the prescription.

6. The method of claim 5, wherein the pharmacy is identified based on a geographic location.

7. The method of claim 1, wherein the health assessment includes a recommendation to consult a physician.

8. The method of claim 7, further comprising the step of generating a referral.

9. The method of claim 8, wherein the referral is based on a geographic location.

10. The method of claim 1, further comprising the step of transmitting the health assessment to a personal physician identified by the user.

11. The method of claim 1, wherein a plurality of questions are communicated to the user and a response to each question is received from the user.

12. The method of claim 1, further comprising the step of identifying the healthcare provider to provide the treatment plan and communicate with the user.

13. The method of claim 1, wherein the user is a patient.

14. The method of claim 1, wherein the user is a caregiver.

15. The method of claim 1, further comprising the step of verifying the identity of the user.

16. The method of claim 1, further comprising the step of determining from the health assessment whether a treatment plan can be provided.

17. The method of claim 1, further comprising the step of changing the health assessment based on input from the healthcare provider.

18. The method of claim 1, further comprising the step of electronically notifying the healthcare provider when a request for healthcare is received.

19. The method of claim 1, wherein the on-line facility for communication between the healthcare provider and the user operates in real time.

20. The method of claim 1, further comprising the step of receiving payment information from the user.

21. The method of claim 20, further comprising the step of updating the payment information when the health assessment is generated.

22. The method of claim 1, further comprising the step of storing the health assessment in a computer-readable storage medium.

23. The method of claim 1, further comprising the step of receiving patient information from the user.

24. The method of claim 23, wherein the patient information includes information relating to a medical history of a patient.

25. The method of claim 23, wherein the patient information includes information relating to current medications being taken by a patient.

26. The method of claim 23, wherein the patient information includes information relating to allergies of a patient.

27. The method of claim 23, wherein the patient information includes height, weight, age and race information for a patient.

28. The method of claim 23, further comprising the step of providing the patient information to the healthcare provider over the network.

29. The method of claim 1, further comprising the step of receiving, within a defined time period, a request from the user for a follow-up health assessment.

30. The method of claim 29, further comprising the step of receiving a selection from the user indicating a previous health assessment for which follow-up is desired.

31. The method of claim 30, further comprising the step of communicating to the user a treatment plan relating to the selected previous health assessment.

32. The method of claim 31, further comprising the step of providing an on-line facility whereby the user and the healthcare provider communicate regarding the selected previous health assessment.

33. The method of claim 29, wherein the defined time period is about forty-eight hours.

34. The method of claim 1, wherein the step of providing an on-line facility further comprises the step of re-establishing communication between the healthcare provider and the user within a defined time period after the assessment is generated.

35. A program comprising:
a first routine for receiving symptom information over a network from a user requesting healthcare,
a second routine for generating a health assessment based on the symptom information,
a third routine for receiving input over a network from a healthcare provider regarding the health assessment, and
a fourth routine for facilitating on-line communication relating to the health assessment between the healthcare provider and the user.

36. The program of claim 35, wherein the input includes a treatment plan.

37. The program of claim 35, wherein the healthcare provider is a physician.

38. The program of claim 37, wherein the treatment plan includes a prescription.

39. The program of claim 35, further comprising a fifth routine for writing a prescription executable by a physician.

40. The program of claim 39, wherein the fifth routine checks a formulary.

41. The program of claim 39, wherein the fifth routine checks for drug interactions.

42. The program of claim 38, further comprising a fifth routine for filling the prescription over the network.

43. The program of claim 35, further comprising a fifth routine for defining a schedule of healthcare providers to provide input and communicate with the user.

44. The program of claim 43, wherein the fifth routine changes the schedule based on input from a healthcare provider.

45. The program of claim 35, further comprising a fifth routine for receiving a request from a patient to notify the patient's personal physician of the treatment plan.

46. The program of claim 45, wherein the fifth routine notifies the personal physician of the health assessment by electronic mail.

47. The program of claim 45, wherein the fifth routine notifies the personal physician of the health assessment by fax.

48. The program of claim 45, wherein the fifth routine notifies the personal physician of the health assessment by postal mail.

49. A system for providing on-line healthcare, the system comprising:
network means for providing a communication network,
means for receiving patient symptom information from a user requesting healthcare over the network means,
processor means coupled to the network means, for generating a health assessment based on the symptom information, and
means for enabling a physician to provide input relating to the health assessment to the user over the network means.

50. The system of claim 49, wherein the means for enabling the physician to provide input includes means for providing an on-line facility for real-time communication between the physician and the user.

51. The system of claim 49, further comprising memory means for storing the health assessment.

52. The system of claim 49, wherein the input includes a prescription.

53. The system of claim 52, further comprising means for enabling the physician to electronically write the prescription.

54. The system of claim 53, further comprising means for transmitting the prescription to a pharmacy over the network means.

55. The system of claim 49, further comprising means for transmitting the health assessment to a personal physician of a patient over the network means.

56. The system of claim 49, further comprising means for scheduling over the network means physicians to provide the input.

57. A method for providing on-line healthcare, the method comprising the steps of:
receiving at a main computer a symptom transmitted by a user via a first remote computing device, the main computer and the first remote computing device being connected by a network,
generating at the main computer a health assessment based on the symptom,
receiving at the main computer input regarding the health assessment transmitted by a healthcare provider via a second remote computing device connected to the network,
providing a facility whereby the healthcare provider and the user communicate regarding the health assessment over the network using the first and second remote computing devices, and
communicating a treatment plan to the user over the network.
